(19) United States
(12) Patent Application Publication
(10) Pub. No.: US 2014/0032717 A1
(43) Pub. Date: Jan. 30, 2014

(54) SYSTEMS AND METHODS OF PROVIDING VISUALLY-ENHANCED DATA TRANSFER INDICATORS

(71) Applicant: Michael A. Sharp, Porter, TX (US)

(72) Inventor: Michael A. Sharp, Porter, TX (US)

(21) Appl. No.: 13/631,420

(22) Filed: Sep. 28, 2012

Related U.S. Application Data
(60) Provisional application No. 61/675,249, filed on Jul. 24, 2012.

(51) Int. Cl. G06F 15/16

(52) U.S. Cl. 709/219

(57) ABSTRACT

As described herein, a method is provided that includes receiving a request to initiate a file transfer from a user's computing device, initiating the file transfer, and delivering supplemental data to the user to run on the user's computing device during the file transfer.

### CROSS-REFERENCE TO RELATED APPLICATION

This application claims the benefit of U.S. Provisional Application No. 61/675,249, which was filed on Jul. 24, 2012 and is incorporated herein by reference in its entirety.

### FIELD

This disclosure is related to methods and systems involving transferring electronic files and, in particular, methods and systems for providing visually-enhanced data transfer indicators.

### BACKGROUND

The frequency and size of data transfers are continually increasing. Despite improvement in the speed of the networks that we use to transfer information, because of the increases in the number of people using networked computing devices, the size of the files that we transfer, and the increasing use of mobile devices on slower networks, users of such devices often find themselves waiting for the completion of a data transfer. As a result, it would be desirable to provide improved systems and methods that can utilize the time, and screen space, currently taken up waiting for data to transfer from one device to another.

### SUMMARY

As described herein, a method is provided that includes receiving a request to initiate a file transfer from a user's computing device, initiating the file transfer, and delivering supplemental data to the user to run on the user's computing device during the file transfer.

In some embodiments, the supplemental data is displayed on the user's computing device during the file transfer. The supplemental data comprises a media file that contains an advertisement. The file transfer can include a file download and/or a file upload. In some embodiments, the media file can be a video file (with or without audio) and in other embodiments, the media file can be an audio file.

In some embodiments, the method can include calculating an amount of time required for the file transfer based on a size of the file and a file transfer speed and providing an indicator during playback of the media file that indicates an amount of time remaining in the file transfer. In some embodiments, the media file can include images associated with a sponsor of the advertisement.

The foregoing and other objects, features, and advantages of the invention will become more apparent from the following detailed description, which proceeds with reference to the accompanying figures.

### BRIEF DESCRIPTION OF THE DRAWINGS

FIGS. 1A-1C illustrate intermediate images (still images) of an animation associated with supplemental data delivered during a file transfer.

FIGS. 1D-1E illustrate other possible intermediate images (still images) of an animation associated with supplemental data delivered during a file transfer.

FIGS. 2A-2D illustrate intermediate images (still images) of another animation that can be associated with supplemental data delivered during a file transfer.

FIGS. 3A and 3B illustrate still images that can be associated with supplemental data delivered during a file transfer.

FIG. 4 is a schematic block diagram of an exemplary computing system on which certain embodiments of the systems and methods disclosed herein can be implemented.

FIG. 5 is a block diagram illustrating a computer network that can be used to perform at least some of the embodiments of the systems and methods disclosed herein.

### DETAILED DESCRIPTION

### General Considerations

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatuses, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “determine” and “provide” to describe the disclosed methods. These terms are high-level abstractions of the actual operations that are performed. The actual operations that correspond to these terms may vary depending on the particular implementation and are readily discernible by one of ordinary skill in the art.

As used herein, the terms “a”, “an” and “at least one” encompass one or more of the specified element. That is, if two of a particular element are present, one of these elements is also present and thus “an” element is present. The terms “a plurality of” and “plural” mean two or more of the specified element. As used herein, the term “and/or” used between the last two of a list of elements means any one or more of the listed elements. For example, the phrase “A, B, and/or C” means “A,” “B,” “C,” “A and B,” “A and C,” “B and C” or “A, B and C.”

Systems and Methods for Providing Visually-Enhanced Data Transfer Indicators

In view of the frequency and the size of data files that are being transferred by users, significant amounts of time are spent by users waiting for transfers to finish. In addition, during such file transfers, the screen is usually not being efficiently used to display content. This is true both when a user uploads or downloads data. The systems and methods described herein addresses the problem of wasted time and screen space as billions of files are being delivered across the Internet and computer networks by providing an opportunity for using this wasted screen time and space.

In conventional systems, when a user presses a key to initiate a download or upload of a file (or other data), they see a spinning circle or a timeline bar. However, this indicator offering provides no value to the sender or recipient. The systems and methods described herein provide an effective and eloquent solution to help address the time lost by providing supplemental data (e.g., visual and/or auditory information) that can be delivered just before, during, or simultaneously with the file being transferred to the recipient. In some embodiments, the supplemental data delivered during downloads and/or uploads can comprise sponsored advertisements. Although the supplemental data can be delivered as part of a downloaded file, in other embodiments, the supplemental data is not part of the download or upload itself—instead, the supplemental data comprises separate, stand-alone products that can be delivered to the recipients computer device, either just before or simultaneously with the initiation of a data transfer.

In some embodiments, the content of the supplemental data can include visual and/or audio content that comprises ad content from a sponsor. For example, sponsors such as PEPSI™ and DOMINOS PIZZA™ can supply ad content that can be displayed during the time it takes to transfer data using a computing device (e.g., a requested file downloaded to a user's computer, smartphone, etc.).

The supplemental data can comprise various media delivery formats. For example, in some embodiments, it can comprise one or more of the following media delivery formats: way, flash, wma, Aiff mov, mp3, jpeg, and/or any other codecs available now and in the future. The supplemental data (e.g., a sponsored advertisement associated with a download or other file transfer) can be added, inserted, and/or instigated for display before or during the download process. In one embodiment, the supplemental data is provided at the time that the transferee (e.g., an intended download recipient) instigates the transfer action. In this manner, the amount of time the supplemental data has to run can be maximized.

Sponsorship of supplemental data can be achieved in various manners. For example, sponsors may pay a fee (or fees) to the company that is transferring content (in the case of a download content delivering organization) or receiving content (in the case of an upload receiving organization). In the case of an organization that provides content for download, for example, the sponsor can pay a fee for each download that includes its supplemental data (e.g., a fee each time a download occurs on a recipient machine where their ad is displayed). The fees can be charged to the sponsors account. Views of the supplemental data and subsequent fees can be recorded by the accounting software component at the organization's servers.

Supplemental data can be served from various locations. In addition to originating with a content deliverer (e.g., a source of content for download) or a content receiver (e.g., a receiver of content by uploads), the supplemental data can be served from third parties that are licensed to provide this data, such as ISPs or destination services like YAHOO™ and FACEBOOK™.

The size of the supplemental data (e.g., sponsored ads) can vary from file to file and, if desired, can be auto stretched to match the length of the file download time. For example, the size and length of a particular download or upload can be calculated and the delivered supplemental content can be optimized to match the time it will take to download to the end user (or upload to another site). In this manner, supplemental data (e.g., ads) and download times can be of same or similar length to fit recipient view time.

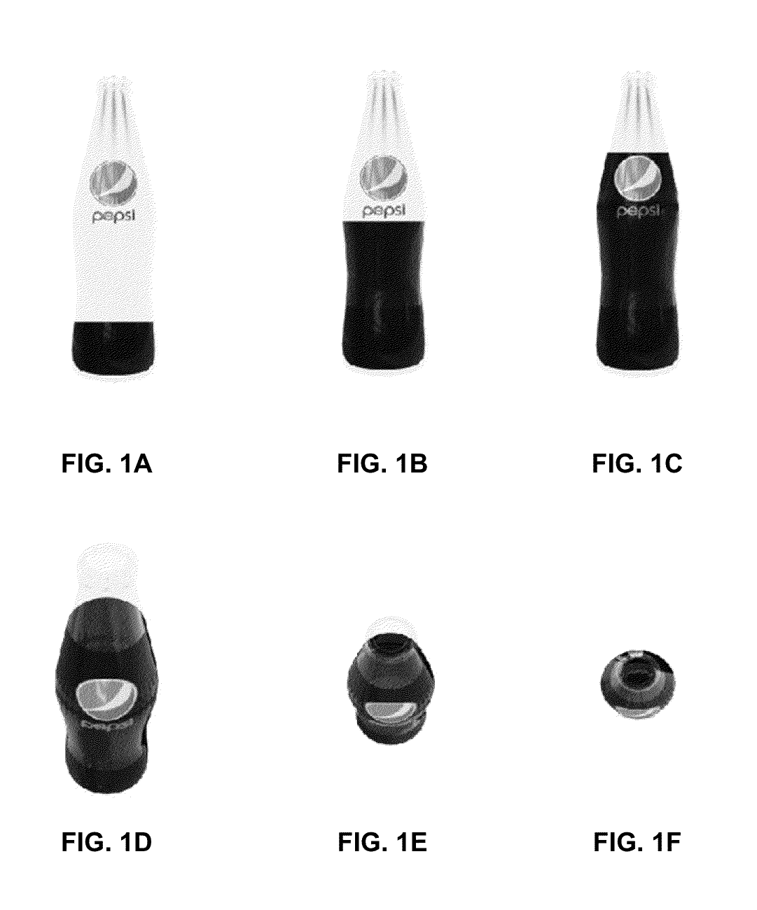

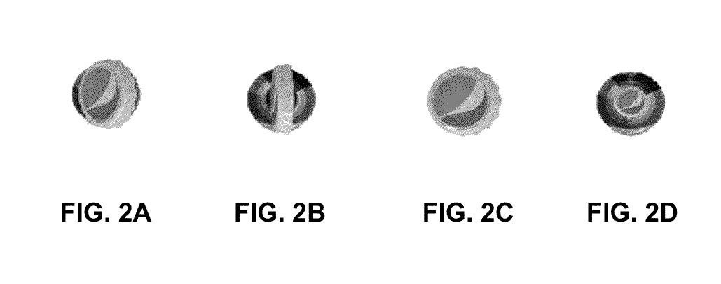

FIGS. 1A-1C illustrate an example of supplemental data that is optimized to match a download or upload time. For example, FIGS. 1A, 1B, and 1C illustrate still images of an animation, showing intermediate states of a “timer” that is based on a sponsored product (e.g., PEPSI™ soda). In this embodiment, as the download starts, the amount of “soda” in the bottle increase at a rate that reflects the amount of time remaining in the transfer. Thus, FIG. 1A illustrates the beginning or early phase of a transfer, FIG. 1B when the transfer is about halfway over, and FIG. 1C when the transfer is nearing completion.

It should be understood that other iconic images associated with a sponsor can be used to reflect a timer. For example, various “filling” actions or “coloring” in of an iconic image (or component thereof) can be used to provide a user with an indication of remaining time while also providing an advertisement for the sponsor.

In addition to “filling” an icon, other graphical displays are possible. For example, as shown in FIGS. 1D, 1E, and 1F, the PEPSI™ bottle is shown spinning from a front view to a top view and when the download is complete (e.g., the soda fills the bottle), another image (e.g., a cap for the bottle) is shown spinning into place onto the bottle.

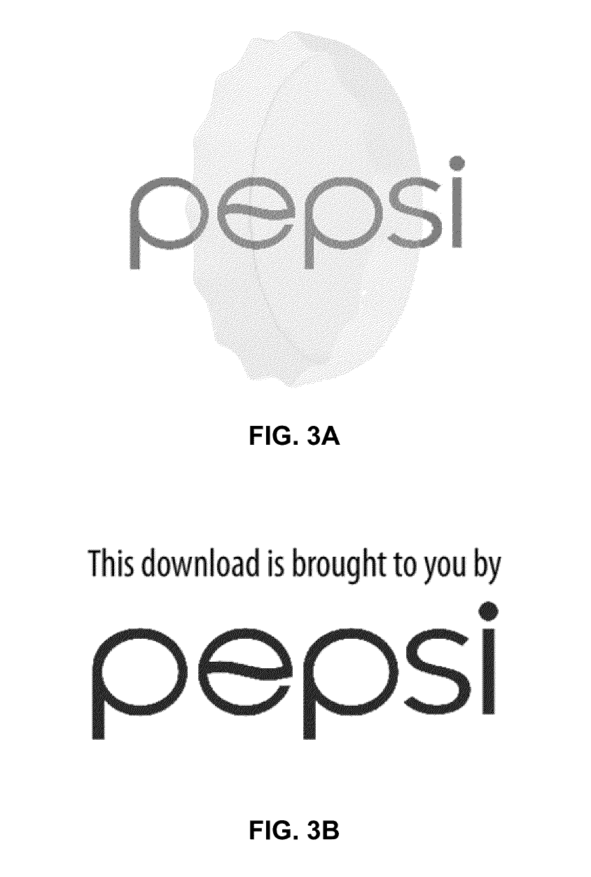

Alternatively, or in addition, once the download is complete, the sponsor can identify themselves. For example, FIGS. 3A and 3B illustrate a simple introduction (FIG. 3A) and a more detailed introduction of the sponsor (FIG. 3B).

Supplemental data can be sent to an ad server (e.g., a third-party supplier of sponsored images/audio content) over the Internet by a party seeking to sponsor or otherwise advertise during file transfers. In some embodiments, the third party must preregister with the supplemental data delivery service (e.g., ad server). This preregistration, for example, may require posting a credit card and submit ads for review and acceptance. Once qualified, the sponsor can begin uploading to the ad server and submit ads of various formats and lengths to be displayed when someone clicks a file to be downloaded to a system (e.g., wi-fi, tv, smartphone, computing device, or other eligible system). In some embodiments, the supplemental data (e.g., ads) can be matched with content keywords and gps location information.

Using the systems and methods described herein, those who provide file transfer systems (either receiving or delivering content) can earn additional revenue by allowing supplemental data to be delivered during file transfers to its users. In this manner, the transfer operator can register with the supplemental data delivery services to receive rewards and/or monetary compensation.

Further participation can be achieved by allowing supplemental data to be delivered with any files a user sends out to friends, family, and/or business customers and relations (such as pictures documents music etc.).

In some embodiments, users can register to join the supplemental data service to help monetize their own computer file upload and download timelines.

Another example of how to monetize the delivery of supplemental data during file transfers would be to allow content that is hosted at social media services (e.g., pictures, movies, and other data) to be associated with supplemental data delivery when those files are accessed by the user and/or other users. In other words, any file content made available for download, upload, and/or delivery to others can be monetized by a user and/or third party that provides the file transfer service.

Implementation of the Systems and Methods Disclosed Herein

Various systems for providing supplemental data to users during file transfer actions are described above. In some embodiments, these systems—including the transfer of files and the associated supplemental data—may be implemented or performed, at least in part, by software stored on one or more tangible computer-readable media (e.g., one or more optical media discs, volatile memory or storage components (such as DRAM or SRAM), or nonvolatile memory or storage components (such as hard drives)) and executed on one or more computing systems. Some basic background information relating to computing systems capable of transferring files as discussed above are provided.

The computing systems can include one or more central processing units (CPUs) and a memory, such as random access memory (RAM) for temporary storage of information and/or a read only memory (ROM) for permanent storage of information, and a mass storage device, such as a hard drive, diskette, or optical media storage device. Typically, the modules of the computing system are connected to the computer using a standards-based bus system, such as, for example, Peripheral Component Interconnect (PCI), Microchannel, SCSI, Industrial Standard Architecture (ISA) and Extended ISA (EISA) architectures. The computing system may also include one or more commonly available input/output (I/O) devices and interfaces, such as a keyboard, a mouse, and/or a touchpad. In one embodiment, the I/O devices and interfaces include one or more display devices, such as a monitor, that allows the visual presentation of data to a user. More particularly, a display device provides for the presentation of Graphical User Interfaces (GUIs), application software data, and multimedia presentations, for example. The computing system may also provide a communications interface to various external devices.

Such software can be executed on a single computer or on a networked computer (e.g., via the Internet, a wide-area network, a local-area network, a client-server network, or other such network). The systems and methods disclosed herein can also be performed using cloud computing, a form of Internet-based computing, whereby shared resources, software and information are provided to computers and other devices on-demand. The software embodiments disclosed herein can be described in the general context of computer-executable instructions, such as those included in program modules, which can be executed in a computing environment on a target real or virtual processor. The computing system may run on a variety of computing devices, such as, for example, a server, a Windows server, a Structure Query Language server, a Unix server, a personal computer, a mainframe computer, a laptop computer, a cell phone, a personal digital assistant, a kiosk, an audio player, and so forth. The computing system is generally controlled and coordinated by operating system software. Conventional operating systems control and schedule computer processes for execution, perform memory management, provide file system, networking, and I/O services, and provide a user interface, such as a graphical user interface, among other things.

Furthermore, any of the software embodiments (comprising, for example, computer-executable instructions for causing a computer to perform any of the disclosed methods) can be transmitted, received, or accessed through a suitable communication means. Similarly, any data structure, data file, intermediate result, or final result created or modified using any of the disclosed methods can be transmitted, received, or accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means now known or unknown. Moreover, any data structure, data file, intermediate result, or final result produced by any of the disclosed methods can be displayed to a user using a suitable display device (e.g., a computer monitor or display). Such displaying can be performed as part of a computer-implemented method of performing any of the disclosed methods.

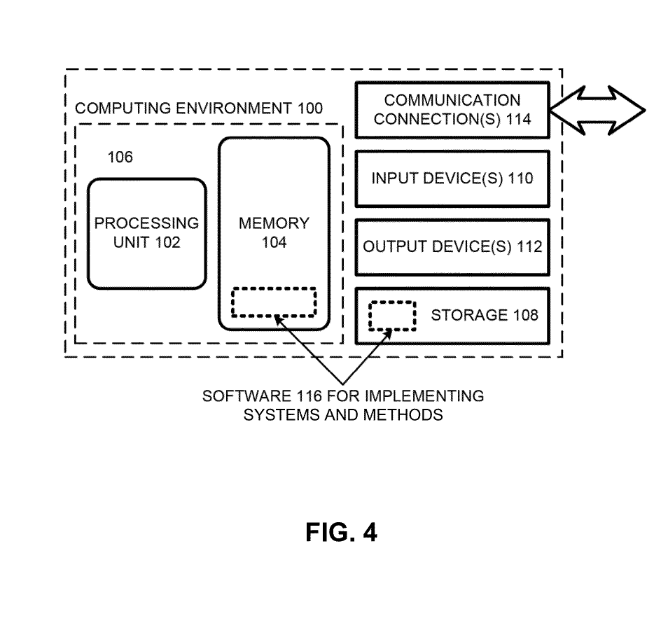

FIG. 4 illustrates a generalized example of a suitable computing environment 100 in which the described embodiments of systems and methods can be implemented. The computing environment 100 is not intended to suggest any limitation as to scope of use or functionality, as the methods described herein can be implemented in diverse general-purpose or special-purpose computing environments.

With reference to FIG. 4, the computing environment 100 includes at least one processing unit 102 and memory 104. In FIG. 4, this most basic configuration 106 is included within a dashed line. The processing unit 102 executes computer-executable instructions and may be a real or a virtual processor. In a multi-processing system, multiple processing units execute computer-executable instructions to increase processing power. The memory 104 may be volatile memory (e.g., registers, cache, RAM), non-volatile memory (e.g., ROM, EEPROM, flash memory, etc.), or some combination of the two. The memory 104 stores software 116 implementing one or more of the systems described herein.

The computing environment can include any suitable computing device, including for example, a smartphone, computer (laptop, desktop, tablet, etc.), or any other computing device capable of receiving supplemental data and performing the function of the supplemental data (e.g., audio and/or visual performance). For example, the computing environment 100 can include storage 108, one or more input devices 110, one or more output devices 112, and one or more communication connections 114. An interconnection mechanism (not shown) such as a bus, controller, or network interconnects the components of the computing environment 100. Typically, operating system software (not shown) provides an operating environment for other software executing in the computing environment 100, and coordinates activities of the components of the computing environment 100. The output device(s) 112 can be a display or another device that provides output from the computing environment 100 to view the selected media content.

The communication connection(s) 114 enable communication over a communication medium to another computing entity so that a file transfer can be achieved. The communication medium is not a storage medium but conveys information such as computer-executable instructions, resource and construction project information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

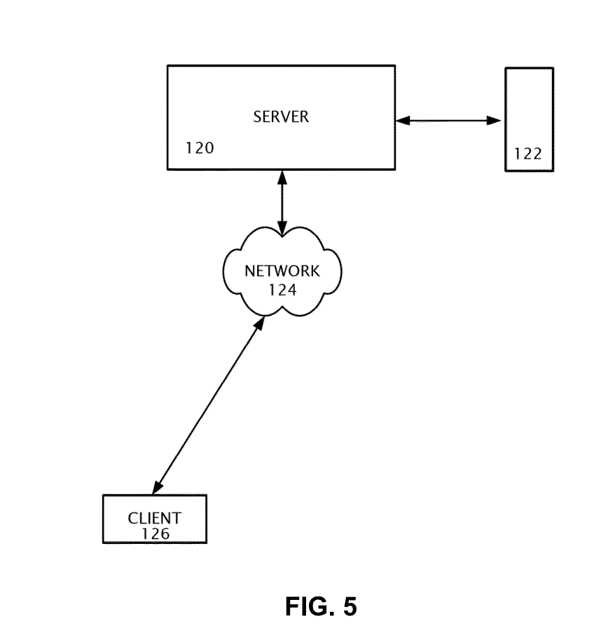

FIG. 5 shows a simplified embodiment of an exemplary network that can achieve file transfers as described herein. A server computer 120, such as an ad server described above, can have an associated storage device 122 (internal or external to the server computer). The server computer 120 can be coupled to a network, shown generally at 124, which can comprise, for example, a wide-area network, a local-area network, a client-server network, the Internet, or other such network. One or more client computer (e.g., a user's computing device), such as those shown at 126 can be coupled to the network 124 using a network protocol. When downloading a file from network 125, supplemental data can be delivered at the same time as the file being transferred from network 125 to user computer 126.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope of these claims.

We claim:

1. A method comprising:
receiving a request to initiate a file transfer from a user's computing device;
initiating the file transfer; and
delivering supplemental data to the user to run on the user's computing device during the file transfer.

2. The method of claim 1, wherein the supplemental data is displayed on the user's computing device during the file transfer.

3. The method of claim 1, wherein the supplemental data comprises a media file that contains an advertisement.

4. The method of claim 1, wherein the file transfer comprises a file download.

5. The method of claim 1, wherein the file transfer comprises a file upload.

6. The method of claim 2, wherein the media file comprises a video file.

7. The method of claim 2, wherein the media file comprises an audio file.

8. The method of claim 2, further comprising:
calculating an amount of time required for the file transfer based on a size of the file and a file transfer speed; and
providing an indicator during playback of the media file that indicates an amount of time remaining in the file transfer.

9. The method of claim 2, wherein the media file comprises images associated with a sponsor of the advertisement.
